(19) United States
(12) Patent Application Publication
(10) Pub. No.: US 2011/0179003 A1
(43) Pub. Date: Jul. 21, 2011

(54) System for Sharing Emotion Data and Method of Sharing Emotion Data Using the Same

(75) Inventors: Hye-Jin MIN, Daejeon (KR); Jong Cheol PARK, Daejeon (KR)

(73) Assignee: KOREA ADVANCED INSTITUTE OF SCIENCE AND TECHNOLOGY, Daejeon (KR)

(21) Appl. No.: 12/691,224

(22) Filed: Jan. 21, 2010

(51) Int. Cl. G06F 17/30; G10L 21/00; H04N 5/44; G09G 5/00; G06F 15/16

(52) U.S. Cl. 707/706; 704/246; 348/734; 345/629; 348/E05.096; 704/E21.001; 709/203; 707/802; 707/E17.141

(57) ABSTRACT

The present invention relates to a system for sharing emotion data and a method of sharing emotion data using the same, which are capable of obtaining collective intelligence through an emotion data set for specific video data, etc. The system for sharing emotion data comprises a plurality of clients each configured to comprise input means for inputting emotion data, storage means for storing the inputted emotion data, and a display unit for displaying integrated data received to input the emotion data; a sharing server configured to comprise formation means for receiving a plurality of the emotion data from the plurality of clients and forming an emotion data set and to transmit the integrated data to the clients; and a main database coupled to the sharing server and configured to store at least any one of the integrated data or the emotion data set formed in the sharing server.

### BACKGROUND OF THE INVENTION

1. Field of the Invention

The present invention relates to a system for sharing emotion data and a method of sharing emotion data using the same, which are capable of obtaining an emotion data through collective intelligence set for specific video data, etc.

2. Background of the Related Art

In the case in which video data, etc. are displayed in a display unit, a user may want to see a desired section of the video or to check which images are included in the video data in each time slot. Such a need results from the characteristic in which contents of the video data cannot be checked at once unlike still images. Today, video data can be played while the speed of play is controlled. However, this method cannot satisfy the needs of a user because of a change in the play speed.

There is technology for setting the leaf of a book in a section being played such that a present video section can be retrieved next time. This method is used when a user wants to see an impressed section of video data again while the video data are being played or to play the video data starting from the impressed section next time. In the case in which the leaf of a book is set, time information is also set. Thus, in the case in which a corresponding video section is displayed next time, only the section in which the leaf of a book has been set can be played back. This method is, however, disadvantageous in that it can be applied to only an image that has been seen once before.

Furthermore, typical video data are disadvantageous in that contents of the video data cannot be checked at once unlike still images. To overcome this problem, there is proposed a player having a function of displaying a snapshot on a time-zone basis. A program for the player is programmed to check a still image, corresponding to a specific section, when a user places the mouse on a specific region and to play the section of the still image when the user clicks on the mouse. In this play method, a user can find desired information in video data which are difficult to see at a glance because a preview function is provided on a time-zone basis.

In this method, a desired section may not be found because the interval between the previews is fixed. Further, there is a problem in that a user is difficult to understand the general flow of the video data through partial still images when first seeing the video data. This method has another disadvantage in that the number of previews is in inverse proportion to the amount of information which can be obtained by a user through the previews.

Furthermore, there is a player in which a user can make a reply to a specific section of video data while viewing the video data. This service method is advantageous in that a user can express his feelings in an impressed scene. However, this method is disadvantageous in that a user cannot check all replies according to the video data at once, there is a possibility that the flow of emotion may be broken because a user may not concentrate on viewing the video data if the process of viewing the video data and the process of making the reply are performed at the same time, and comprehensive information in which replies written by several users are clustered cannot be transferred.

As described above, the present video indexing technology from the viewpoint of user convenience is low as compared with the development of pertinent technology. Accordingly, there is a need for a new indexing method which is capable of checking the general flow of the video data and satisfying the needs of a user by playing desired sections on an emotion basis.

### SUMMARY OF THE INVENTION

Accordingly, the present invention has been made in view of the above problems occurring in the prior art, and it is an object of the present invention to provide indexing technology in which, when a client receives an emotion data set and displays integrated data pertinent to the emotion data set, the general emotion information about the integrated data is provided to a user such that the user can understand the general flow of the integrated data.

The user can display the integrated data using the input means of the client and, at the same time, input emotion data for a pertinent section and transmit the inputted emotion data to a sharing server. The sharing server forms an emotion data set having collective intelligence by integrating a plurality of the emotion data received from a plurality of the clients.

In the case in which, when first coming into contact with integrated data, a user receives such a emotion data set from the sharing server and executes the integrated data and the emotion data set at the same time, the user can know the general flow of video data, which contents are included in which section of the video data, and where the major sections will be placed. Accordingly, there are provided a system for sharing emotion data and a method of sharing emotion data using the same, which are capable of providing a user with convenience information.

An aspect of the present invention provides a system for sharing emotion data, comprising a plurality of clients each configured to comprise input means for inputting emotion data, storage means for storing the inputted emotion data, and a display unit for displaying integrated data received to input the emotion data; a sharing server configured to comprise formation means for receiving a plurality of the emotion data from the plurality of clients and forming an emotion data set and to transmit the integrated data to the clients; and a main database coupled to the sharing server and configured to store at least any one of the integrated data or the emotion data set formed in the sharing server.

### BRIEF DESCRIPTION OF THE DRAWINGS

Further objects and advantages of the invention can be more fully understood from the following detailed description taken in conjunction with the accompanying drawings.

FIG. 1 is a block diagram of a system for sharing emotion data according to the present invention.

FIG. 2 is a table showing integrated data play times, specific emotion types, user IDs, the intensities of emotion, and integrated data IDs.

FIG. 3 shows emotion data converted into data of a Meta file format.

FIG. 4 shows a detailed example of a shape in which an emotion data set is displayed in the display unit.

FIG. 5A shows the construction of the system for sharing emotion data in which the selection and play means is formed of voice recognition means.

FIG. 5B is a plan view of a remote control including selection and play means.

FIG. 6A shows the construction of the system for sharing emotion data in which search means is formed of voice recognition means.

FIG. 6B shows a shape in which a result of the search by the search means is displayed through a popup window.

FIG. 7 is a flowchart illustrating a method of sharing emotion data according to a first embodiment of the present invention;

FIG. 8 is a flowchart illustrating a method of sharing emotion data according to a second embodiment of the present invention; and

FIG. 9 is a flowchart illustrating a method of sharing emotion data according to a third embodiment of the present invention.

### DETAILED DESCRIPTION OF THE PREFERRED EMBODIMENT

(Construction of System for Sharing Emotion Data)

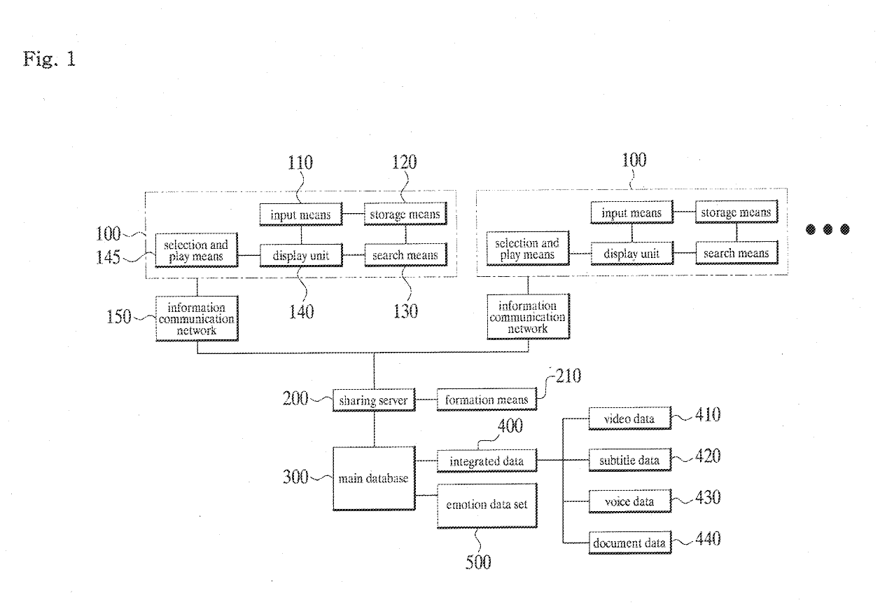

The construction of a system for sharing emotion data according to the present invention is described in detail below with reference to the accompanying drawings. First, FIG. 1 is a block diagram of the system for sharing emotion data according to the present invention.

As shown in FIG. 1, the system for sharing emotion data includes a plurality of clients 100 coupled to a sharing server 200 over an information communication network 150. The information communication network 150 can include a wired network, a wireless network, the Internet, DFMA, CDMA, or Global System for Mobile communication (GSM). The sharing server 200 is equipped with formation means 210 for forming an emotion data set 500 having collective intelligence by integrating a plurality of emotion data 510 (refer to FIG. 3). The sharing server 200 is coupled with a main database 300 for storing and managing integrated data 400 or the emotion data set 500.

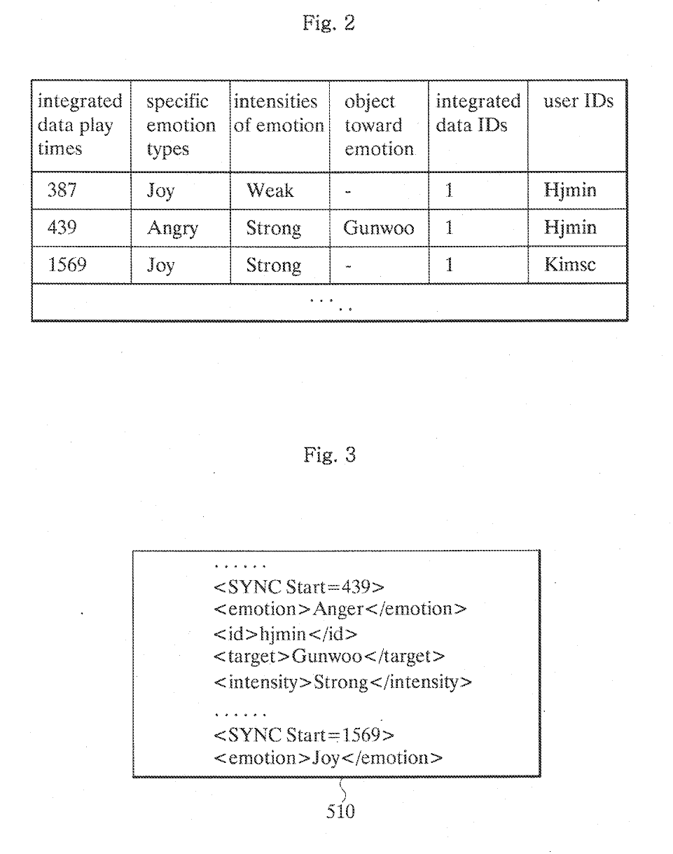

A user views the integrated data 400, displayed in a display unit 140, in real time and, at the same time, classify the types of the data on an emotion basis and inputs the classified data using input means 110. The emotion-based types are preset letters, and a third party can objectively understand the expressions of emotion. For example, the emotion types can include ‘Happy’, ‘Sad’, ‘Angry’, ‘Fear’, ‘Joy’, and ‘Surprised’. A user can input such expressions of emotion in real time while the integrated data 400 are being displayed. For example, a user can input his emotion in a table shown in FIG. 2. Referring to FIG. 2, a user can input an integrated data play time, a specific emotion type, a user ID, the intensity of emotion, an integrated data ID, etc. It will be evident to those skilled in the art that the contents of the input can be modified. The emotion data 510 having a raw data format are automatically converted into data of a Meta file format without special manipulation by a user.

As another exemplary input method, if a user assigns hot keys to ‘Happy’, ‘Sad’, ‘Angry’, ‘Fear’, and ‘Joy’, respectively (for example, Windows Key+H (Happy), Windows Key+S (Sad), Windows Key+A (Angry), Windows Key+F (Fear), and Windows Key+J (Joy)) and enters them, the system transmits the contents to the sharing server 200. Accordingly, the user can input the emotion data 510 more conveniently.

As yet another exemplary input method, a player for executing the integrated data 400 can provide an interface having buttons indicative of respective emotion types. Thus, a user can easily input his specific emotions by clicking on the buttons corresponding to the respective specific emotions, and the inputted emotions are transmitted to the sharing server 200.

FIG. 3 shows the emotion data 510 converted into data of a Meta file format. As shown in FIG. 3, ‘<SYNC Start=439>’ indicates integrated data play time information, ‘<emotion>Angry</emotion>’ indicates an emotion type, ‘<id>hjmin</id>’ indicates a user ID, and ‘<target>Gunwoo</target>’ indicates the object toward emotion. Furthermore, ‘<intensity>Strong</intensity>’ indicates the intensity of emotion.

After the emotion data 510 are inputted through the input means 110, in order to indicate that the inputted data are a file pertinent to the emotion data 510, the inputted data are configured in a markup language and stored in storage means 120. In the case of video data 410, the markup language has a ‘smi’ file format, and so subtitle data 420 are provided to foreign video articles. The start point of the video data 410 is indicated by ‘ms’, and subtitles stored in a tag at the corresponding point are displayed. In a similar way, the emotion data 510 can be configured using a markup language, and so emotion data 510 can be provided at a corresponding point of the video data 410. A detailed example of the markup language can include ‘esmi’.

The display unit 140 displays the integrated data 400 received from the sharing server 200. The integrated data 400 includes the video data 410, and the video data 410 can further include the subtitle data 420, document data 440, voice data 430, etc. Accordingly, a user can input the emotion data 510 while seeing the video data 410 being displayed.

Referring back to FIG. 1, the plurality of clients 100 is coupled to the sharing server 200. The sharing server 200 receives the emotion data 510, stored in the clients 100, from the clients 100. The formation means 210 of the sharing server 200 forms the emotion data set 500 having collective intelligence by integrating the plurality of emotion data 510 of a Meta file format, received from the plurality of clients 100. In this case, the emotion data set 500 also has the Meta file format. In other words, the plurality of emotion data received from the plurality of clients 100 is integrated to form a single emotion data set 500 having the Meta file format.

In detailed examples of the method of forming the emotion data set 500 having collective intelligence, the emotion data 510 of a Meta file format, including all pieces of information, can be gathered to form the emotion data set 500. Furthermore, after a specific section is designated, a plurality of the emotion data 510 received from the plurality of clients 100 can be clustered, and only representative emotional expressions can be generated to have a Meta file format. Alternatively, user IDs can be grouped into a specific group ID, instead of using the ID of each user, and the emotion data set 500 of a Meta file format can be formed on a group basis.

In more detail, the method of forming the emotion data set 500 includes the two kinds; the method of forming the emotion data set 500 by integrating the emotion data of all users and the method of generating the representative emotion data 510 by clustering a plurality of emotion data in a specific section. In the first method, if the number of users is increased, information can be spread to all detailed sections (ms unit). In this case, the second method can be used with efficiency taken into consideration. K-mean clustering, Principle Component Analysis (PCA), Basic Linear Classification, etc. can be used as such a clustering method. As described above, the emotion data set 500 of the present invention has a Meta file format having collective intelligence, and the method of forming the emotion data set 500 is not limited to the above examples.

The emotion data set 500 is stored in the main database 300. If a user requests the emotion data set 500, the sharing server 200 transmits the emotion data set 500 to the corresponding client 100 of the user.

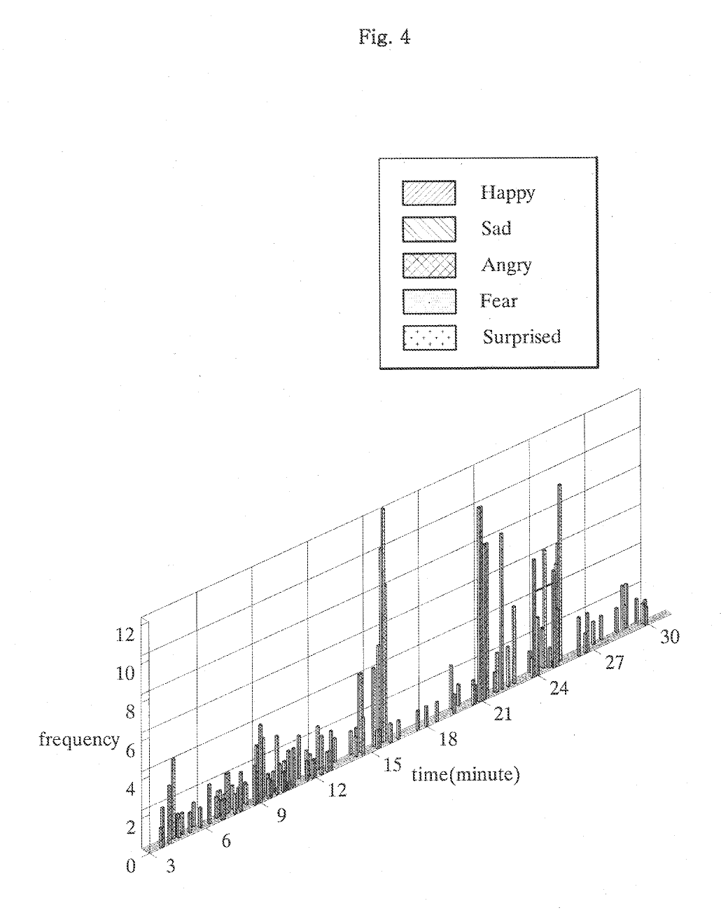

If the client 100 receives the emotion data set 500 corresponding to the integrated data 400, the display unit 140 displays the integrated data 400 and the emotion data set 500. FIG. 4 shows a detailed example of a shape in which the emotion data set 500 is displayed in the display unit 140 and shows the statistics of a change in the emotion according to time. In FIG. 4, the vertical axis indicates time, and the abscissa axis indicates an emotional frequency. Here, the shape of the emotion data set 500 displayed may be various, and it is evident that the scope of the present invention is not limited to any detailed shape as long as collective intelligence can be recognized through the shape.

The propensity of a group according to emotion can be known at a corresponding point based on the displayed emotion data set 500. Information can be provided in connection with the corresponding point of the integrated data 400. Accordingly, a user can understand the general flow of a video article that has never been seen before and can also analyze the general flow of emotion. Furthermore, the user can select and view a section corresponding to a desired specific emotion. For example, in the case in which a user views the emotion data set 500 shown in FIG. 4, the user can understand the general change of emotion of the integrated data 400 and will recognize that there is an angry group emotion at about 16 minutes. Accordingly, if the user wants to see such an emotion section, the user can select and play the 16-minutes section.

The display unit 140 further includes selection and play means 145. Thus, a user can select the emotion data set 500 based on collective intelligence and play the selected emotion data set using the selection and play means 145. For example, in the case in which a specific emotion frequency (for example, ‘Happy’) of the emotion data set 500 exceeds a preset reference value at a corresponding point, the section of the video data 410 corresponding to the section in which the specific emotion frequency exceeds the preset reference value is classified as the section of the video data 410 corresponding to a specific emotion. Thus, if a user inputs a specific letter (for example, H) using the selection and play means 145, the selection and play means 145 selects only the section of the video data 410, classified as the desired specific emotion (for example, ‘Happy’ or ‘Joy’) and plays the selected section. For example, assuming that the reference value is 2 in the emotion data set 500 shown in FIG. 4 and displayed in the display unit 140, sections exceeding 2 can be classified on an emotion basis. If ‘H’ is inputted through the selection and play means 145, video of a section classified as happy emotion can be partially played, or video can be played starting from the corresponding point. Next, if ‘H’ is pressed, the section classified as the happy emotion can be played.

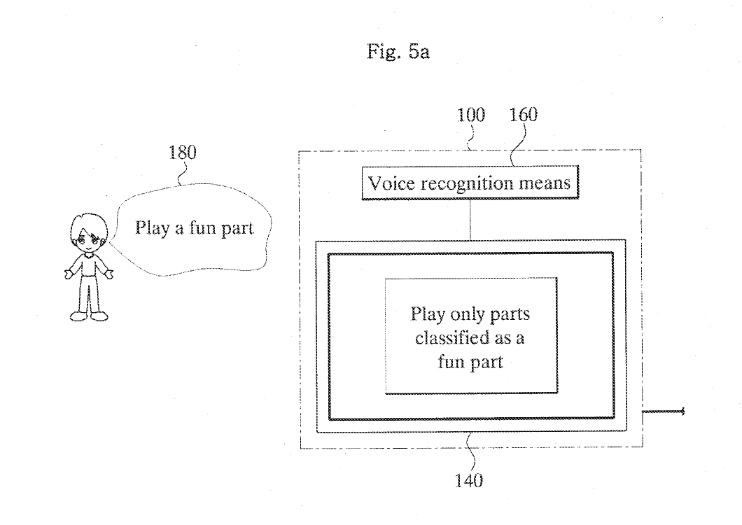

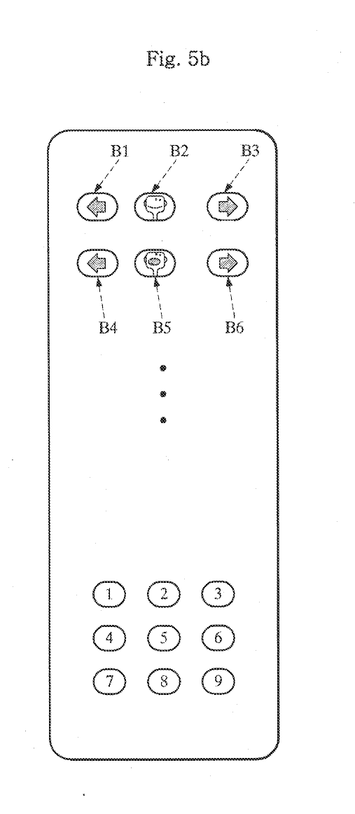

The selection and play means 145 can be implemented using a specific key of the keyboard on a personal computer (PC) or can be formed of voice recognition means 160. FIG. 5A shows the construction of the system for sharing emotion data in which the selection and play means 145 is formed of the voice recognition means 160. Referring to FIG. 5A, in the case in which the integrated data 400 and the emotion data set 500 are displayed, a user can input voice information pertinent to tag information through voice, find the video data 410 classified on an emotion basis in response thereto, and display an image, etc. having a desired specific emotion.

Furthermore, the selection and play means 145 or the search means 130 can be included in a remote control 146 (refer to FIG. 5B) as well as a specific key of the keyboard on a PC or the voice recognition means 160. FIG. 5B is a plan view of the remote control 146 including the selection and play means 145, the search means 130, or a tagging means. In more detail, referring to FIG. 5B, when a button B2 (or B5) is pressed, the tagging means equipped in the remote control allows the section of the video data 410 to be tagged as a specific emotion, such as ‘Happy’ (when the button B5 is pressed, ‘Surprised’). When a button B1 (or B4) is pressed, a section, existing right before the present section of the video data 410 and classified as a happy emotion, can be navigated and played. When a button B3 (or B6) is pressed, a section, existing next to the present section of the video data 410 and classified as a next happy emotion, can be navigated and played.

The client 100 can further include search means 130. The search means 130 is coupled to the sharing server 200 and is used to search the main database 300, storing the integrated data 400 and the emotion data set 500, for data indicative of a specific emotion desired by a user. The sharing server 200 transmits the desired data of the integrated data 400 or the emotion data set 500 to the corresponding client 100.

First, the main database 300 is configured to classify the integrated data 400 and the emotion data set 500 relating to the integrated data 400 on an emotion basis. That is, the main database 300 is configured to determine which integrated data 400 represent which specific emotion based on the collective intelligence of the emotion data set 500. For example, in the shape of the emotion data set 500 pertinent to the specific integrated data 400 shown in FIG. 4 (also displayed in the display unit 150), a specific emotion having the highest frequency is ‘Angry’. Accordingly, the integrated data 400 and the pertinent emotion data set 500 are classified as emotion ‘Angry’. In such classification, emotion data sets having a Meta file format are automatically classified.

Furthermore, such emotion-based classification can be performed over the entire integrated data 400, or sections corresponding to specific emotions of the emotion data set 500 can be partially classified. Accordingly, sections corresponding to specific emotions, from among a plurality of the integrated data 400, can be gathered and classified. Here, the integrated data 400 in themselves are not segmented and classified, but which section corresponds to which specific emotion is indexed and classified through the emotion data set 500.

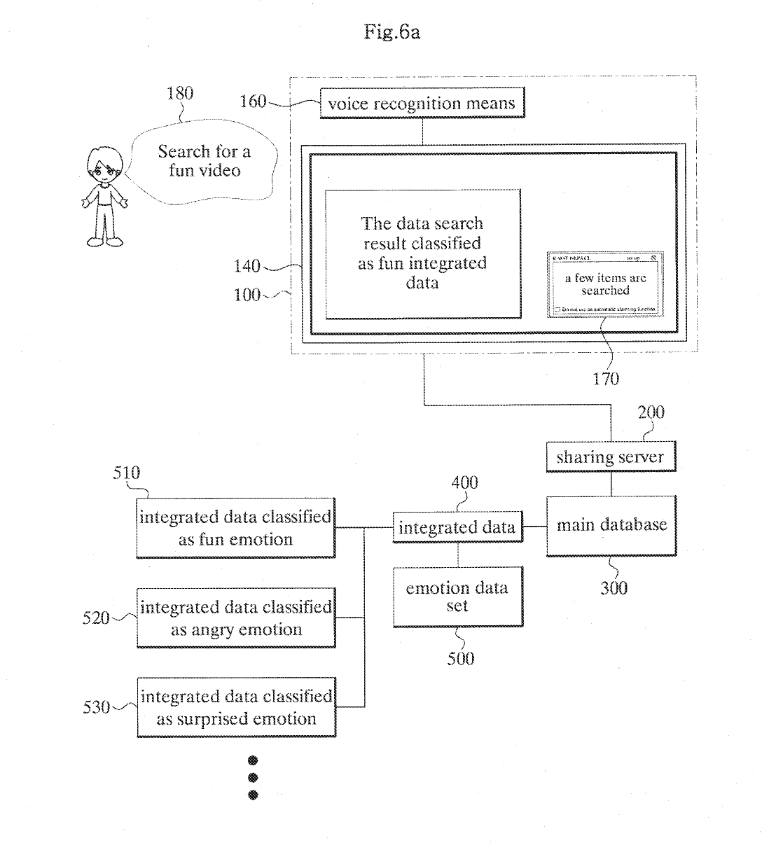

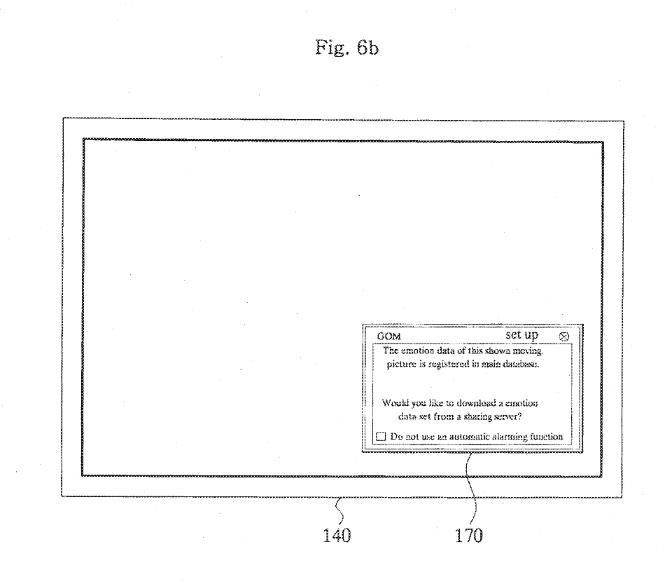

If a user wants the integrated data 400 and the emotion data set 500 for a specific emotion, the user can search for data classified and stored in the main database 300 using the search means 130. A result of the search can be displayed through a popup window 170 (refer to FIG. 6B). Here, the integrated data 400 in themselves, classified based on specific emotions, can be searched for or sections of the integrated data 400, indicative of specific emotions, can be searched for using the search means 130. According to a result of the search, the user can receive the desired integrated data 400 and the desired emotion data set 500 from the sharing server 200. The user can display the integrated data 400 and the emotion data set 500 corresponding to the specific emotion.

Furthermore, in the case in which only the integrated data 400 are stored and displayed in the client 100, the search means 130 can search the main database 300 for the emotion data set 500 pertinent to the displayed integrated data 400. FIG. 6A shows the construction of the system for sharing emotion data in which the search means 130 is formed of the voice recognition means 160.

FIG. 6B shows a shape in which a result of the search by the search means 130, regarding whether the pertinent emotion data set 500 exists, is displayed through the popup window 170. Referring to FIG. 6A, whether or not the emotion data set 500 exists is displayed through the popup window 170, and so whether the emotion data set 500 relating to the integrated data 400 exists in the main database 300 can be known. If a user wants to receive the emotion data set 500, the sharing server 200 transmits the emotion data set 500 to the corresponding client 100. Thus, the user can obtain collective intelligence about the integrated data 400.

Furthermore, such search means 130 can be not only implemented using a specific key of the keyboard on a PC, but formed of the voice recognition means 160. FIG. 6A shows the construction of the system for sharing emotion data in which the search means 130 is formed of the voice recognition means 160. Thus, if a user inputs voice information pertinent to tag information on which a specific emotion can be recognized, the voice recognition means 160 searches the main database 300 for the integrated data 400 and the emotion data set 500 having the specific emotion. A result of the search is displayed through the popup window 170. The user can receive the desired integrated data 400 or emotion data set 500 from the sharing server 200.

(Method of Sharing Emotion Data Using the System for Sharing Emotion Data)

Hereinafter, first, second, and third embodiments of the method of sharing emotion data are described with reference to the accompanying drawings. The present invention illustrates the embodiments for allowing those skilled in the art to readily implement the embodiments, and the scope of the present invention is defined by the claims. Therefore, the present invention is not limited to the embodiments.

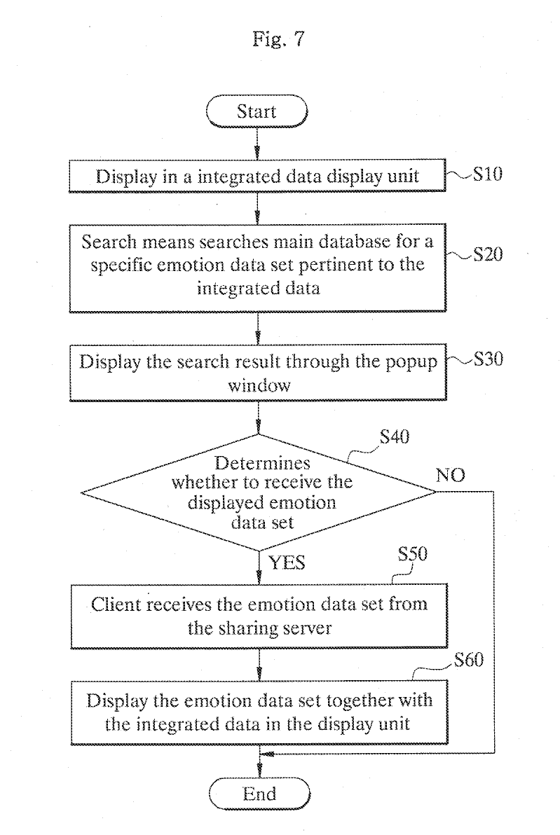

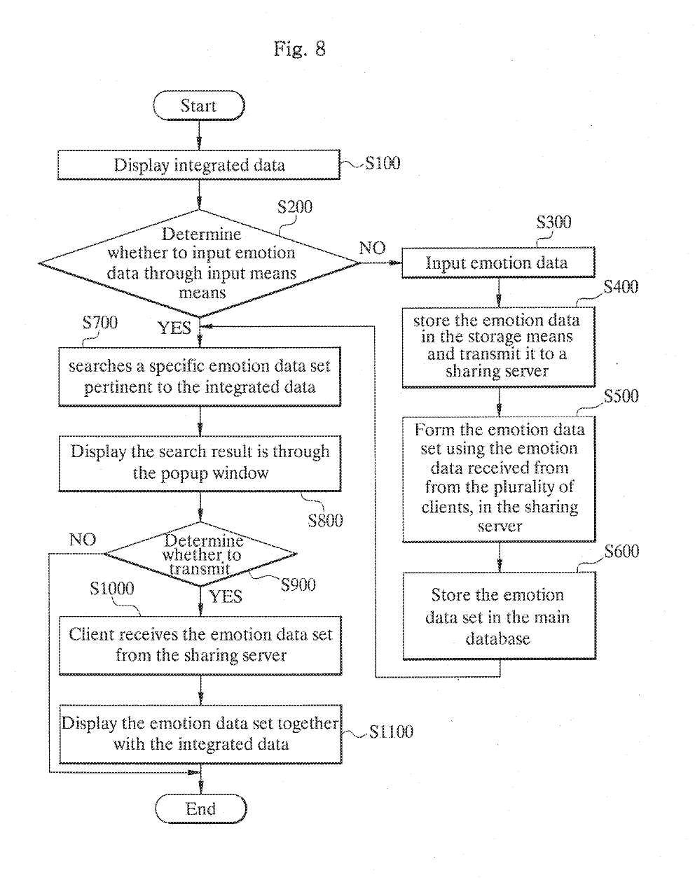

FIG. 7 is a flowchart illustrating a method of sharing emotion data according to the first embodiment of the present invention. Referring to FIG. 7, first, the integrated data 400 are received from the sharing server 200 and displayed in the display unit 140 of the client 100 at step S10. The search means 130 of the client 100 searches the main database 300 for a specific emotion data set 500 pertinent to the displayed integrated data 400 at step S20.

The retrieved emotion data set 500 is displayed through the popup window 170 at step S30. Next, a user determines whether to receive the displayed emotion data set 500 at step S40. If, as a result of the determination at step S40, the user is determined to receive the emotion data set 500, the client 100 receives the emotion data set 500 from the sharing server 200 at step S50. The received emotion data set 500, together with the integrated data 400, is displayed. Collective intelligence about the integrated data 400 is provided to the user in real time at step S60. Accordingly, the user can understand the general flow of emotion by checking the emotion data set 500, play only the major sections of video, or play sections corresponding to desired emotions.

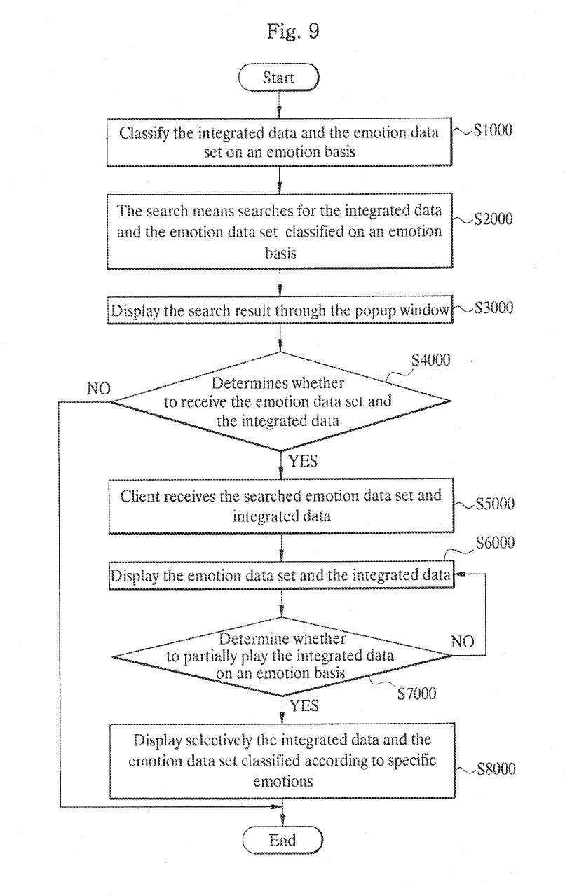

FIG. 8 is a flowchart illustrating a method of sharing emotion data according to the second embodiment of the present invention. Referring to FIG. 8, first, the integrated data 400 are received from the sharing server 200 and displayed in the display unit 140 of the client 100 at step S100. While the integrated data 400 are displayed, a user determines whether to input the emotion data 510 for the integrated data 400 at step S200.

If, as a result of the determination at step S200, the user is determined to input the emotion data 510, the user, as described above, inputs the emotion data 510 using a letter, having time information and capable of objectively expressing his emotion, through the input means 110 at step S300. As an exemplary input method, as described above, if the user assigns hot keys to ‘Happy’, ‘Sad’, ‘Angry’, ‘Fear’, and ‘Joy’, respectively (for example, Windows Key+H (Happy), Windows Key+S (Sad), Windows Key+A (Angry), Windows Key+F (Fear), and Windows Key+J (Joy)) and enters them, the system transmits the contents to the sharing server 200, which stores them in the form of letters. Accordingly, the user can input the emotion data 510 more conveniently.

As another exemplary input method, a player for executing the integrated data 400 can provide an interface having buttons indicative of respective emotion types. Thus, a user can easily input his specific emotions by clicking on the buttons corresponding to the respective specific emotions, and the inputted emotions are transmitted to the sharing server 200. The sharing server 200 stores the received emotions in the form of letters.

Next, the inputted emotion data 510 are automatically converted into data of a Meta file format, stored in the storage means 120 of the client 100, and then transmitted to the sharing server 200 at step S400. The sharing server 200 is also coupled to other clients 100 over the information communication network 150, and it can receive a plurality of the emotion data 510 from the plurality of clients 100.

Next, the formation means 210 of the sharing server 200 forms the emotion data set 500 of a Meta file format using the plurality of emotion data 510 at step S500. Such an emotion data set 500 has collective intelligence indicative of a real-time group emotion for specific integrated data 400. The formed emotion data set 500 is stored in the main database 300 at step S600.

If, as a result of the determination at step S200, the user is determined not to input the emotion data 510 or if the formed emotion data set 500 is stored in the main database 300 at step S600, the search means 130 of the client 100 searches the main database 300 for a specific emotion data set 500 pertinent to the displayed integrated data 400 at step S700.

The retrieved emotion data set 500 is displayed through the popup window 170 at step S800. Next, the user determines whether to receive the emotion data set 500 at step S900. If, as a result of the determination at step S900, the user is determined to receive the emotion data set 500, the client 100 receives the emotion data set 500, stored in the main database 300, from the sharing server 200 at step S1000. The received emotion data set 500, together with the integrated data 400, is displayed, and collective intelligence about the integrated data 400 is provided to the user in real time at step S1100. Accordingly, the user can understand the general flow of emotion by checking the emotion data set 500, play only the major sections of video, or play sections corresponding to desired emotions.

FIG. 9 is a flowchart illustrating a method of sharing emotion data according to the third embodiment of the present invention. Referring to FIG. 9, first, the main database 300 classifies the integrated data 400 and the emotion data set 500 on an emotion basis at step S1000. As described above, all integrated data 400 can be classified as the whole unit, or sections of the integrated data 400, corresponding to respective specific emotions, can be classified.

If a user wants to search for the integrated data 400 and the emotion data set 500 for every emotion, the search means 130 searches for the integrated data 400 and the emotion data set 500 classified on an emotion basis at step S2000. A method of searching for the integrated data 400 and the emotion data set 500, as described above, may be performed by inputting a specific letter, or may be performed through voice in the case in which the search means 130 is formed of the voice recognition means 160. A result of the search is displayed through the popup window 170 in order to let the user know the result of the search at step S3000. The user determines whether to receive the retrieved integrated data 400 or the retrieved emotion data set 500 at step S4000.

If, as a result of the determination at step S4000, the user is determined to receive the retrieved integrated data 400 or the retrieved emotion data set 500, the user can receive the retrieved integrated data 400 or the retrieved emotion data set 500 completely or selectively through the client 100 from the sharing server 200 at step S5000. In the case in which the retrieved integrated data 400 or the retrieved emotion data set 500 is received through the client 100, the integrated data 400 classified according to desired specific emotions and the pertinent emotion data set 500 are displayed in the display unit 140 at step S6000. Next, the user determines whether to partially play the integrated data 400 on an emotion basis using the selection and play means 145 at step S7000.

If, as a result of the determination at step S4700, the user is determined to partially play the integrated data 400 on an emotion basis, the user selectively displays sections of the integrated data 400, classified according to desired specific emotions, using the selective play apparatus at step S8000.

As described above, the embodiments of the present invention have an advantage in that collective intelligence about integrated data can be known because an emotion data set relating to the integrated data is provided.

The emotion data set is stored in the main database and can be transmitted to other clients coupled to the sharing server. Thus, the collective intelligence can be shared between the clients. Accordingly, there is an advantage in that any client can provide its emotion data forming the emotion data set and can receive and use the formed emotion data set.

In the case in which both integrated data and an emotion data set are stored in a client, a user can know how group emotion will come out in a specific section while the integrated data is displayed and can also obtain such information even from a video that the user sees it for the first time. Accordingly, if a user wants to see an image having a specific emotion, the user can play and see a corresponding section. Further, there is an advantage in that a user can view all the scenes of several programs without missing any important scene or desired scene when the user wants to see the several programs at the same time.

Furthermore, when integrated data are executed, whether an emotion data set relating to the integrated data is stored in the main database can be searched for. Accordingly, there is an advantage in that a user can receive an emotion data set from the sharing server when the user wants to conveniently obtain collective intelligence about the integrated data. Furthermore, integrated data and emotion data sets are classified on an emotion basis and stored in the main database. Accordingly, there is an advantage in that a client can search for desired emotion-based integrated data and a desired emotion data set and can also receive desired data.

Furthermore, while integrated data and emotion data are executed in the display unit, a user can partially play images on an emotion basis using the selection and play means. Accordingly, there is an advantage in that the user's convenience can be improved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for sharing emotion data, comprising:
a plurality of clients each configured to comprise input means for inputting emotion data, storage means for storing the inputted emotion data of Meta file format, and a display unit for displaying integrated data received to input the emotion data;
a sharing server configured to comprise formation means for receiving the emotion data inputted from each of the clients and forming an emotion data set and to transmit the integrated data to the clients; and,
a main database coupled to the sharing server and configured to store at least any one of the integrated data or the emotion data set formed in the sharing server.

2. The system for sharing emotion data according to claim 1,
wherein the emotion data is the Meta file which is pertinent to the integrated data in real time through the input means when the integrated data is displayed in the display unit, and has sensitivity information for a specific emotion, the sensitivity information comprising typical emotion information and further comprising at least one of the intensity of emotion, the object of emotion expression, and inputer information,
wherein the formation means forms the emotion data set of Meta file format having collective intelligence by integrating a plurality of the emotion data received from each of the clients,
wherein forming the emotion data set comprises integrating all of the sensitivity information of the received emotion data, or clustering the emotion data after the designation of specific section, thereby forming the representative emotion of each cluster into the emotion data set.

3. The system for sharing emotion data according to claim 2,
wherein clustering method is K-mean clustering, Principle Component Analysis (PCA) or Basic Linear Classification.

4. The system for sharing emotion data according to claim 2,
wherein the representative emotion can be measured by any one of a start point, an average point, a peak point, or a middle point.

5. The system for sharing emotion data according to claim 1,
wherein the integrated data comprises video data, and may further comprises any one of subtitle data, document data, and voice data.

6. The system for sharing emotion data according to claim 1,
further comprising an information communication network by which each of the clients is coupled to the sharing serve, the information communication network being a wired network, a wireless network, the Internet, DFMA, CDMA, or Global System for Mobile communication (GSM)

7. The system for sharing emotion data according to claim 2,
wherein the emotion data set received from the clients, together with the integrated data, is displayed when the integrated data is displayed in the display unit, and provides the collective intelligence about emotion data set.

8. The system for sharing emotion data according to claim 2,
wherein the client further include search means, the search means coupled to the sharing server and used to search information about the integrated data and the emotion data set.

9. The system for sharing emotion data according to claim 8,
wherein if the integrated data is displayed in the display unit, the search means searches the main database for the emotion data set pertinent to the integrated data, and displays the result of the search in the display unit through the popup window.

10. The system for sharing emotion data according to claim 9,
wherein the search means searches the main database for the integrated data and the emotion data set classified on an emotion basis, and the sharing server transmits any one of the integrated data and the emotion data set to the clients.

11. The system for sharing emotion data according to claim 2,
wherein the display unit further comprises selection and play means, so that if the sharing server transmits the integrated information and the emotion data set relating to the integrated information to the clients, and displays them in the display unit, the integrated data is partially displayed by being classified according to desired specific emotion based on the emotion data set.

12. The system for sharing emotion data according to claim 10,
wherein the search means is corresponding to voice recognition means,
if a user inputs voice information relating to the specific emotion in the voice recognition means,
the voice recognition means recognizes the voice information, and searches the integrated data and the emotion data set stored in the main database, and
the sharing server transmits the integrated data and the emotion data set to the clients, and the integrated data and the emotion data set are displayed in the display unit.

13. The system for sharing emotion data according to claim 8,
wherein the system for sharing emotion data is transferred to the cluster corresponding to the specific emotion by the search means.

14. The system for sharing emotion data according to claim 11,
wherein the system for sharing emotion data is transferred to the cluster corresponding to the specific emotion by the selection and play means.

15. The system for sharing emotion data according to claim 13,
wherein the search means is equipped with a remote control, and if the specific button of the remote control is pressed, the search means recognizes the sensitivity information relating to specific emotion, and the display units partially displays the integrated data classified on an emotion basis; wherein the remote control further comprises a tagging means, and if another specific button of the remote control is pressed, the tagging means allows the section of the video data to be tagged as a specific emotion.

16. The system for sharing emotion data according to claim 11,
wherein the selection and play means is corresponding to voice recognition means, so that if a user inputs voice information relating to the specific emotion in the voice recognition means, while the emotion data set and the integrated data are displayed in the display unit,
the voice recognition means recognizes the voice information, and the display units partially displays the integrated data classified on an emotion basis.

17. A method for sharing emotion data using the system for sharing emotion data of claim 8, comprising:
a step in which the integrated data are received from the sharing server and displayed in the display unit;
a step in which the search means searches the main database for emotion data set pertinent to the integrated data;
a step in which an user determines whether to receive the emotion data set;
a step in which the client receives the emotion data set stored in the main database from the sharing server; and
a step in which the emotion data set, together with the integrated data, is displayed in the display unit.

18. A method for sharing emotion data using the system for sharing emotion data of claim 12, comprising:
a step in which the integrated data are received from the sharing server and displayed in the display unit;
a step in which the user determines whether to input emotion data through input means, and the emotion data of Meta file is in real time inputted to the integrated data;
a step in which the inputted emotion data is stored in the storage means, and transmitted to the sharing server;
a step in which the sharing server receives a plurality of the emotion data, and forms emotion data set of a Meta file format having collective intelligence through the emotion data;
a step in which the formed emotion data set is stored in main database;
a step in the search means searches the main database for the emotion data set pertinent to the integrated data;
a step in which user determines whether to receive the emotion data set;
a step in which the client receives the emotion data set stored in the main database from the sharing server; and,
a step in which the emotion data set, together with the integrated data, is displayed in the display unit.

19. A method for sharing emotion data using the system for sharing emotion data of claim 13, comprising:
a step in which the main database classifies the integrated data and the emotion data set on an emotion basis;
a step in which the search means searches for the integrated data and the emotion data set classified on an emotion basis;
a step in the search means searches the main database for the emotion data set pertinent to the integrated data;
a step in which the user determines whether to receive the integrated data and the emotion data set, and receive the integrated data and the emotion data set completely or selectively through the client from the sharing server; and
a step in which the integrated data and the emotion data set are displayed in the display unit.

20. The method for sharing emotion data according to claim 19,
wherein the selection and play means is corresponding to voice recognition robot,
if a user inputs voice information relating to a specific emotion to the voice recognition robot, while the integrated data and the emotion data set are displayed in the display unit,
the voice recognition means recognizes the voice information, and the display units partially displays the integrated data classified on an emotion basis.
